(19) United States
(12) Patent Application Publication
(10) Pub. No.: US 2026/0180098 A1
(43) Pub. Date: Jun. 25, 2026

(54) ELECTRIC STORAGE APPARATUS

(71) Applicant: TOYOTA JIDOSHA KABUSHIKI KAISHA, Toyota-shi (JP)

(72) Inventors: Kenji BABA, Seto-shi (JP); Keita AOYAMA, Kasugai-shi (JP)

(73) Assignee: TOYOTA JIDOSHA KABUSHIKI KAISHA, Toyota-shi (JP)

(21) Appl. No.: 19/416,379

(22) Filed: Dec. 11, 2025

(30) Foreign Application Priority Data
Dec. 19, 2024 (JP) 2024-223732

(51) Int. Cl. H01M 50/24; H01M 10/613; H01M 10/6566

(52) U.S. Cl. CPC H01M 50/24; H01M 10/613; H01M 10/6566

(57) ABSTRACT

An electric storage apparatus capable of suppressing an adverse effect of water entering the inside of a housing on an electric equipment is provided. In an electric storage apparatus, a housing includes: a frame being able to be assembled using a fastening member; a partition member fixable to the frame using a fastening member, the partition member being configured to partition an inside of the housing into a space in which an electric equipment is housed and another space; and a crown member fixed to the frame. The partition member includes a water stop part in each of right and left end parts of the partition member, and the water stop part is covered with the crown member in a state where the partition member is disposed above the electric equipment.

### CROSS REFERENCE TO RELATED APPLICATIONS

This application is based upon and claims the benefit of priority from Japanese patent application No. 2024-223732, filed on Dec. 19, 2024, the disclosure of which is incorporated herein in its entirety by reference.

### BACKGROUND

The present disclosure relates to an electric storage apparatus.

An ordinary electric storage apparatus has a configuration in which, for example, a storage battery is housed inside a housing. Note that, for example, Patent Literature 1 discloses a housing in which a support column and a beam of the housing can be assembled via a bracket.

[Patent Literature 1] Japanese Unexamined Patent Application Publication No. 2001-307697

### SUMMARY

In an ordinary electric storage apparatus, when the inside of the housing is divided into a space housing an electric equipment and another space, it is desirable to prevent water from entering the space housing the electric equipment from the other space and suppress an adverse effect of water entering the inside of the housing on the electric equipment.

The present disclosure provides an electric storage apparatus capable of suppressing an adverse effect of water entering the inside of a housing on an electric equipment.

An electric storage apparatus according to an aspect of the present disclosure is an electric storage apparatus including: an electric equipment including a storage battery; and a housing configured to house the electric equipment, in which
the housing includes:
   a frame including column units and a beam member configured to couple the column units to each other, the frame being able to be assembled using a fastening member;
   a partition member fixable to the frame using a fastening member, the partition member being configured to partition an inside of the housing into a space in which the electric equipment is housed and another space; and
   a crown member fixed to the frame, and
the partition member includes a water stop part in each of right and left end parts of the partition member, and the water stop part is covered with the crown member in a state where the partition member is disposed above the electric equipment.

In the above-described electric storage apparatus, the partition member preferably supports a temperature control apparatus configured to cool a refrigerant for cooling the electric equipment, and preferably forms a temperature control space inside the housing,
the housing preferably includes a first communication port and a second communication port each configured to communicate with the temperature control space, and
the temperature control apparatus is preferably disposed in an air flow path between the first communication port and the second communication port.

In the above-described electric storage apparatus, the first communication port is preferably disposed in a rear part of the housing,
the second communication port is preferably disposed in at least one of a left part of the housing and a right part of the housing,
the partition member preferably includes a support part that supports the temperature control apparatus, and a wall part that rises upward from a front end part of the support part, the wall part preferably being configured to guide air that has flown into the temperature control space through the first communication port and then passed through the temperature control apparatus to the second communication port, and
the water stop part is preferably formed in each of the support part and the wall part.

In the above-described electric storage apparatus, the water stop part preferably has a labyrinth structure.

According to the present disclosure, it is possible to provide an electric storage apparatus capable of suppressing an adverse effect of water entering the inside of a housing on an electric equipment.

The above and other objects, features and advantages of the present disclosure will become more fully understood from the detailed description given hereinbelow and the accompanying drawings.

### BRIEF DESCRIPTION OF DRAWINGS

FIG. 1A is a perspective view of an electric storage apparatus according to an embodiment when viewed from an X-axis positive side;

FIG. 1B is a perspective view of the electric storage apparatus according to the embodiment when viewed from an X-axis negative side;

FIG. 2 is a diagram of an internal structure of the electric storage apparatus according to the embodiment when viewed from a Y-axis positive side;

FIG. 3 is a diagram showing a configuration of the electric storage apparatus according to the embodiment near a first space when viewed from a Z-axis positive side;

FIG. 4A is a perspective view showing a frame and a partition member of a housing in the electric storage apparatus according to the embodiment;

FIG. 4B is a perspective view showing a column unit of the frame in the electric storage apparatus according to the embodiment;

FIG. 5A is a perspective view showing a configuration of the electric storage apparatus according to the embodiment near the partition member;

FIG. 5B is a perspective view showing the partition member in the electric storage apparatus according to the embodiment; and

FIG. 5C is a cross-sectional view showing the arrangement of water stop parts and a crown member of the partition member in the electric storage apparatus according to the embodiment.

### DESCRIPTION OF EMBODIMENTS

Specific embodiments to which the present disclosure is applied will be described hereinafter in detail with reference to the drawings. However, the present disclosure is not limited to the following embodiments. Further, for the clarification of the description, the following descriptions and drawings are simplified as appropriate.

First, a configuration of an electric storage apparatus according to this embodiment will be described. The following description will be given using a three-dimensional (XYZ) coordinate system in order to clarify the description. Note that, for example, an X-axis positive side is the front side of the electric storage apparatus, an X-axis negative side is the rear side of the electric storage apparatus, a Y-axis positive side is the left side of the electric storage apparatus, a Y-axis negative side is the right side of the electric storage apparatus, a Z-axis positive side is the upper side of the electric storage apparatus, and a Z-axis negative side is the lower side of the electric storage apparatus.

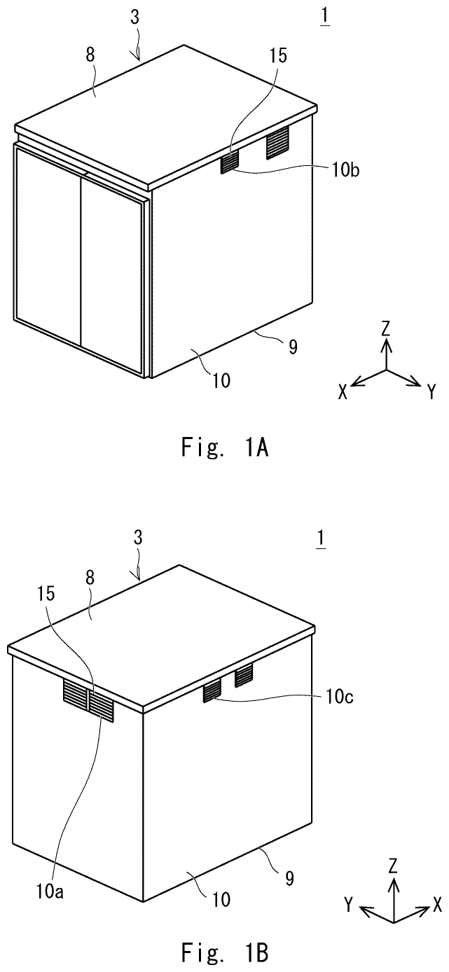

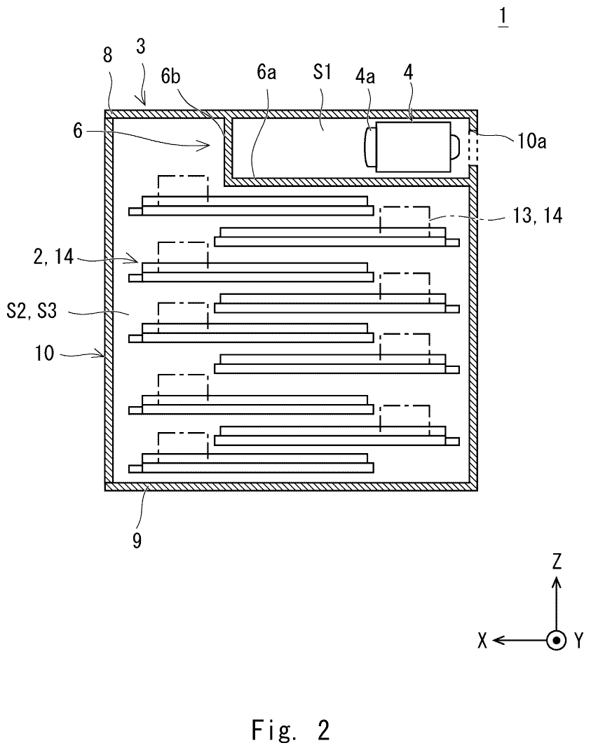

FIG. 1A is a perspective view of the electric storage apparatus according to this embodiment when viewed from the X-axis positive side. FIG. 1B is a perspective view of the electric storage apparatus according to this embodiment when viewed from the X-axis negative side. FIG. 2 is a diagram of an internal structure of the electric storage apparatus according to this embodiment when viewed from the Y-axis negative side.

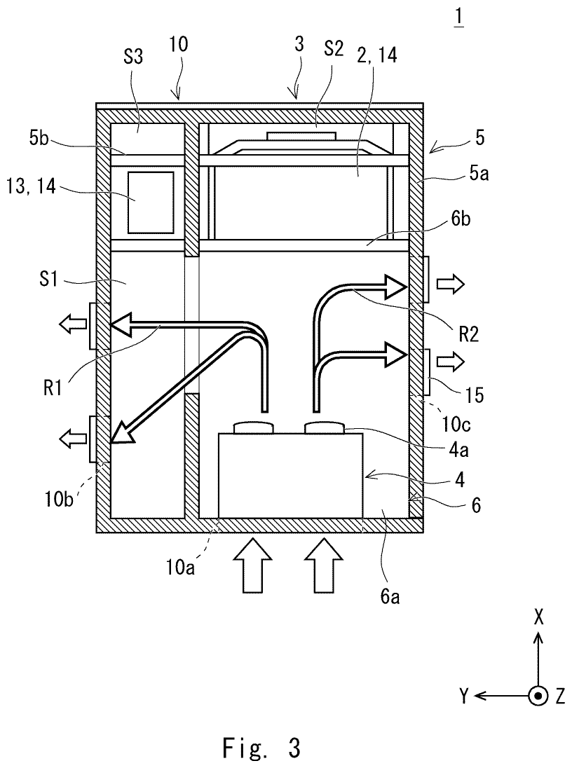

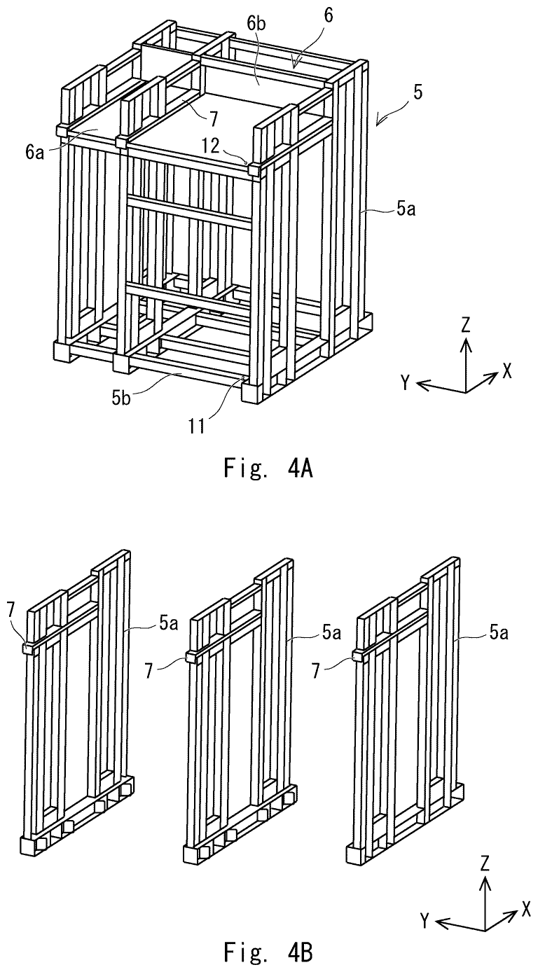

FIG. 3 is a diagram showing a configuration of the electric storage apparatus according to this embodiment near a first space when viewed from a Z-axis positive side. FIG. 4A is a perspective view showing a frame and a partition member of a housing in the electric storage apparatus according to this embodiment. FIG. 4B is a perspective view showing a column unit of the frame in the electric storage apparatus according to this embodiment.

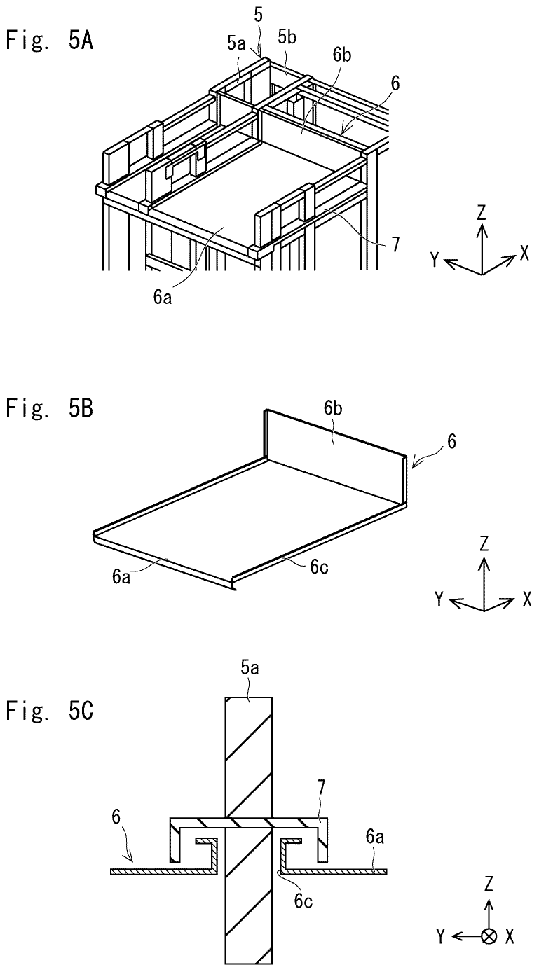

FIG. 5A is a perspective view showing a configuration of the electric storage apparatus according to this embodiment near the partition member. FIG. 5B is a perspective view showing the partition member in the electric storage apparatus according to this embodiment. FIG. 5C is a cross-sectional view showing the arrangement of water stop parts and a crown member of the partition member in the electric storage apparatus according to this embodiment.

An electric storage apparatus 1 includes, for example, battery packs 2, a housing 3, and a temperature control apparatus 4 as shown in FIGS. 1A, 1B, 2, and 3. The battery pack 2 is a storage battery and has, for example, a configuration substantially similar to that of a general vehicle-mounted battery pack.

The battery pack 2 is formed by housing a battery module inside the housing, and may be, for example, a lithium-ion battery, a nickel-hydrogen battery, a nickel-cadmium battery, or an all-solid-state battery. As shown in FIG. 2, for example, the battery pack 2 has a substantially rectangular shape when viewed in the Z-axis direction and a flat plate shape substantially parallel to the XY plane. The battery packs 2 are stacked in the Z-axis direction.

As shown in FIGS. 1A, 1B, 2, 3, 4A, and 4B, for example, the housing 3 has a box shape and includes a frame 5, a partition member 6, crown members 7, a roof part 8, a floor part 9, and a side wall part 10. The frame 5 includes, for example, column units 5a and a beam member 5b, and is assembled using bolts 11 or the like which are representative examples of fastening members.

Note that, in FIG. 4A, only a representative bolt 11 is shown. As shown in FIGS. 4A and 4B, for example, the column units 5a are formed of combination of hollow square members. The column units 5a are disposed substantially parallel to the XZ plane and at intervals in the Y-axis direction.

In this embodiment, for example, as shown in FIGS. 4A and 4B, three of the column units 5a are disposed at intervals in the Y-axis direction. The beam member 5b is formed of, for example, a hollow square member. The beam member 5b extends in the Y-axis direction and connects the adjacent column units 5a in the Y-axis direction.

As shown in FIGS. 5A and 5B, for example, the partition member 6 is a plate member bent in a substantially L-shape when viewed in the Y-axis direction. The partition member 6 includes a support part 6a, a wall part 6b, and water stop parts 6c. The support part 6a, for example, supports the temperature control apparatus 4 as shown in FIG. 2.

As shown in FIGS. 5A and 5B, for example, the support part 6a is disposed substantially parallel to the XY plane. The wall part 6b projects from the end part of the support part 6a on the X-axis positive side toward the Z-axis positive side and is disposed substantially parallel to the YZ plane.

As shown in FIGS. 5A and 5C, for example, the water stop parts 6c are formed in the end parts of the support part 6a and the wall part 6b on the Y-axis positive side, and in the end parts of the support part 6a and the wall part 6b on the Y-axis negative side. The water stop part 6c preferably has, for example, a labyrinth shape in which the end part of the support part 6a in the Y-axis direction is folded back into a substantially C-shape.

At this time, as shown in FIG. 5C, for example, the parts of the water stop parts 6c formed in the support part 6a are folded back inward from the respective end parts of the support part 6a in the Y-axis direction to the surface of the support part 6a on the Z-axis positive side.

Specifically, the parts of the water stop parts 6c formed in the support part 6a include, for example, a first part which rises from the end part of the support part 6a in the Y-axis direction toward the Z-axis positive side and is substantially parallel to the XZ plane, and a second part which is folded back from the end part of the first part on the Z-axis positive side toward the inner side of the support part 6a in the Y-axis direction and is substantially parallel to the XY plane.

Further, the parts of the water stop parts 6c formed in the wall part 6b are, for example, folded back inward from the respective end parts of the wall part 6b in the Y-axis direction to the surface of the wall part 6b on the X-axis negative side. Specifically, the parts of the water stop parts 6c formed in the wall part 6b include, for example, a first part which rises from the end part of the wall part 6b in the Y-axis direction toward the X-axis negative side and is substantially parallel to the XZ plane, and a second part which is folded back from the end part of the first part on the X-axis negative side toward the inner side of the wall part 6b in the Y-axis direction and is substantially parallel to the YZ plane.

As shown in FIG. 4A, the above-described partition member 6 is disposed so as to extend from the column unit 5a of the frame 5 on the Y-axis positive side to the central column unit 5a of the frame 5, and so as to further extend from the column unit 5a of the frame 5 on the Y-axis negative side to the central column unit 5a of the frame 5.

Further, as shown in FIG. 2, the partition member 6 is disposed in the part of the frame 5 on the Z-axis positive side and on the X-axis negative side. That is, the partition member 6 is disposed so as to cover a corner part of the frame 5 on the Z-axis positive side and on the X-axis negative side.

As shown in FIG. 4A, the partition member 6 is fixed to a jig (not shown) fixed to the frame 5 using bolts 12 or the like which are representative examples of fastening members. Note that, in FIG. 4A, only a representative bolt 12 is shown.

At this time, as shown in FIG. 2, the end part of the support part 6a of the partition member 6 on the X-axis negative side reaches the end part of the frame 5 on the X-axis negative side, and the end part of the wall part 6b of the partition member 6 on the Z-axis positive side reaches the end part of the frame 5 on the Z-axis positive side.

Thus, as shown in FIGS. 2 and 3, the inside of the housing 3 includes a first space S1, a second space S2, and a third space S3. The first space S1 is a space surrounded by the partition member 6 inside the housing 3. The temperature control apparatus 4 is disposed in the first space S1.

For example, as shown in FIGS. 2 and 3, the second space S2 is a space between the column unit 5a on the Y-axis negative side and the central column unit 5a inside the housing 3 excluding the first space S1. The battery packs 2 are housed in the second space S2 in a state in which they are stacked on each other. Further, the battery packs 2 are fixed to the frame 5.

As shown in FIGS. 2 and 3, for example, the third space S3 is a space between the column unit 5a on the Y-axis positive side and the central column unit 5a inside the housing 3 excluding the first space S1. A control apparatus 13 such as a power control unit that controls each of the battery packs 2 is housed in the third space S3.

Further, the control apparatus 13 is fixed to the frame 5. That is, the inside of the housing 3 is partitioned by the partition member 6 into the second space S2 and the third space S3 in which an electric equipment 14 including the battery packs 2 and the control apparatus 13 is disposed, and the first space S1 other than these spaces.

As shown in FIGS. 5A and 5C, for example, the crown member 7 covers the parts of the water stop parts 6c formed in the support part 6a from the Z-axis positive side, and covers the parts of the water stop parts 6c formed in the wall part 6b from the X-axis negative side. The electric storage apparatus 1 according to this embodiment includes the crown member 7 on the Y-axis positive side, the crown member 7 on the Y-axis negative side, and the central crown member 7.

As shown in FIG. 5C, for example, these crown members 7 are formed by bending a C-shaped channel member in which the Z-axis negative side thereof is opened into a substantially L-shape. That is, the crown member 7 includes, for example, a first part having a substantially C-shape in which the Z-axis negative side thereof is opened and extending in the X-axis direction, and a second part having a substantially C-shape in which the X-axis positive side thereof is opened and extending from the end part of the first part on the X-axis positive side toward the Z-axis positive side.

Further, as shown in FIG. 5A, the crown member 7 on the Y-axis positive side is fixed to the column unit 5a on the Y-axis positive side, the crown member 7 on the Y-axis negative side is fixed to the column unit 5a on the Y-axis negative side, and the central crown member 7 is fixed to the central column unit 5a.

At this time, as shown in FIG. 5A, the crown member 7 on the Y-axis positive side, the crown member 7 on the Y-axis negative side, and the central crown member 7 are disposed at substantially the same height positions in the Z-axis direction. Further, the water stop part 6c of the partition member 6 on the Y-axis positive side disposed between the column unit 5a on the Y-axis positive side and the central column unit 5a is housed inside the crown member 7 on the Y-axis positive side.

The water stop part 6c of the partition member 6 on the Y-axis negative side disposed between the column unit 5a on the Y-axis negative side and the central column unit 5a is housed inside the crown member 7 on the Y-axis negative side. Further, as shown in FIG. 5C, the water stop part 6c of the partition member 6 on the Y-axis negative side disposed between the column unit 5a on the Y-axis positive side and the central column unit 5a is housed in the space inside the central crown member 7 on the Y-axis positive side.

As shown in FIG. 5C, the water stop part 6c of the partition member 6 on the Y-axis positive side disposed between the column unit 5a on the Y-axis negative side and the central column unit 5a is housed in the space inside the central crown member 7 on the Y-axis negative side.

As shown in FIGS. 1A and 1B, the roof part 8 covers an open part of the frame 5 on the Z-axis positive side. The floor part 9 covers an open part of the frame 5 on the Z-axis negative side. The side wall part 10 covers an open part of the frame 5 on the X-axis positive side, an open part of the frame 5 on the X-axis negative side, an open part of the frame 5 on the Y-axis positive side, and an open part of the frame 5 on the Y-axis negative side.

As shown in FIG. 1A, for example, the side wall part 10 on the X-axis positive side may be formed by an openable/closable door. As shown in FIG. 1B, a first communication port 10a is formed in the side wall part 10 on the X-axis negative side.

As shown in FIGS. 2 and 3, the first communication port 10a communicates the part of the first space S1 on the X-axis negative side with the outside. The first communication port 10a, for example, is disposed in a part between the column unit 5a on the Y-axis negative side and the central column unit 5a in the side wall part 10 on the X-axis negative side, and on the Z-axis positive side with respect to the support part 6a of the partition member 6.

As shown in FIG. 1A, second communication ports 10b is formed in the side wall part 10 on the Y-axis positive side. The second communication ports 10b communicate the part of the first space S1 on the Y-axis positive side with the outside. The second communication ports 10b, for example, are disposed in the part on the X-axis negative side of the side wall part 10 on the Y-axis positive side and on the Z-axis positive side of the side wall part 10 on the Y-axis positive side at intervals in the X-axis direction.

As shown in FIG. 1B, third communication ports 10c are formed in the side wall part 10 on the Y-axis negative side. The third communication ports 10c communicate the part of the first space S1 on the Y-axis positive side with the outside. The third communication ports 10c, for example, are disposed in the part on the X-axis negative side of the side wall part 10 on the Y-axis negative side and on the Z-axis positive side of the side wall part 10 on the Y-axis negative side at intervals in the X-axis direction.

As shown in FIGS. 1A and 1B, a louver 15 is preferably fitted into each of the first communication port 10a, the second communication ports 10b, and the third communication ports 10c. The temperature control apparatus 4, for example, cools a refrigerant circulating in the electric equipment 14 in order to cool the electric equipment 14.

The temperature control apparatus 4 can cool a refrigerant by bringing air (i.e., outside air) taken in by a fan 4a into contact with a refrigerant circuit in which the refrigerant circulates. Therefore, the first space S1 of the housing 3 functions as a temperature control space.

As shown in FIG. 2, the temperature control apparatus 4 is fixed to a part of the support part 6a of the partition member 6 on the X-axis negative side. At this time, the temperature control apparatus 4 may be disposed so as to overlap the first communication port 10a of the housing 3 when viewed in the X-axis direction.

Note that, in FIG. 3, the flow of air flowing into the first space S1 is indicated by arrows. In the above configuration, for example, air flowing into the first space S1 of the housing 3 through the first communication port 10a of the housing 3 by the fan 4a of the temperature control apparatus 4 is drawn to the X-axis positive side by the fan 4a, come into contact with the refrigerant circuit in the temperature control apparatus 4 to cool a refrigerant, and then come into contact the wall part 6b of the partition member 6.

As a result, the air that has come into contact with the wall part 6b of the partition member 6 is divided into the Y-axis positive side and the Y-axis negative side, and the air guided to the Y-axis positive side is discharged from the second communication ports 10b of the housing 3, and the air guided to the Y-axis negative side is discharged from the third communication ports 10c of the housing 3. That is, the wall part 6b of the partition member 6 functions as an air guiding part that guides air to the second communication ports 10b and the third communication ports 10c.

Therefore, air can be satisfactorily discharged from the first space S1 of the housing 3. Further, when air is not discharged from the X-axis positive side of the housing 3 and the X-axis positive side of the housing 3 is set as the front surface of the electric storage apparatus 1, the generation of noise at the front surface of the electric storage apparatus 1 can be suppressed.

At this time, the temperature control apparatus 4 is disposed in a first air flow path R1 between the first communication port 10a and the second communication port 10b and a second air flow path R2 between the first communication port 10a and the third communication port 10c.

Next, a water stop structure of the electric storage apparatus 1 according to this embodiment will be described. In the electric storage apparatus 1 according to this embodiment, water such as rainwater may enter the first space S1 through the first communication port 10a, the second communication ports 10b, and the third communication ports 10c of the housing 3.

In such a case, water moves along the support part 6a of the partition member 6, and is stopped by the water stop part 6c of the partition member 6. Further, since the water stop part 6c of the partition member 6 is covered with the crown member 7, water can be prevented from entering a gap between the water stop part 6c of the partition member 6 and the frame 5. Therefore, water can be prevented from entering the second space S2 and the third space S3 from the first space S1, and an adverse effect of the water on the electric equipment 14 can be suppressed.

As described above, the electric storage apparatus 1 according to this embodiment has a configuration in which the partition member 6 includes the water stop part 6c and the water stop part 6c is covered with the crown member 7. Therefore, water moving along the support part 6a of the partition member 6 can be stopped by the water stop part 6c of the partition member 6.

Further, since the water stop part 6c of the partition member 6 is covered with the crown member 7, water can be prevented from entering a gap between the water stop part 6c of the partition member 6 and the frame 5. Therefore, the electric storage apparatus 1 according to this embodiment can prevent water from entering the second space S2 and the third space S3 from the first space S1, and suppress an adverse effect of the water on the electric equipment 14.

In particular, when the water stop part 6c of the partition member 6 has a labyrinth structure, water moving along the support part 6a of the partition member 6 can be reliably stopped by the water stop part 6c of the partition member 6.

Moreover, the electric storage apparatus 1 according to this embodiment is configured so that the frame 5 can be assembled using fastening members, and the partition member 6 can be fixed to the frame 5 using fastening members. At this time, for example, in a state where the frame 5 is disassembled into the column units 5a and the beam member 5b and the partition member 6 is not fixed to the frame 5, the column units 5a, the beam member 5b, and the partition member 6 are painted in a painting booth, and then the frame 5 is assembled and the partition member 6 is fixed to the frame 5. Therefore, the size of the housing 3 can be prevented from being restricted by the size of a painting booth.

Further, when the electric storage apparatus 1 according to this embodiment is configured so that the wall part 6b of the partition member 6 guides air to the second communication ports 10b and the third communication ports 10c, the air can be satisfactorily discharged from the first space S1 of the housing 3. Further, when air is not discharged from the X-axis positive side of the housing 3 and the X-axis positive side of the housing 3 is set as the front surface of the electric storage apparatus 1, the generation of noise at the front surface of the electric storage apparatus 1 can be suppressed.

Note that the shape of the water stop part 6c of the partition member 6 according to this embodiment is merely an example, and any shape by which water moving along the support part 6a of the partition member 6 can be stopped may be employed. Further, the configuration of the temperature control apparatus 4 is merely an example, and any configuration by which the electric equipment 14 can be cooled may be employed.

Although the electric storage apparatus 1 according to this embodiment has a configuration in which the battery packs 2 are stacked in the Z-axis direction, it is sufficient to include a single or a plurality of storage batteries.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An electric storage apparatus comprising: an electric equipment including a storage battery; and a housing configured to house the electric equipment, wherein
the housing comprises:
a frame including column units and a beam member configured to couple the column units to each other, the frame being able to be assembled using a fastening member;
a partition member fixable to the frame using a fastening member, the partition member being configured to partition an inside of the housing into a space in which the electric equipment is housed and another space; and
a crown member fixed to the frame, and
the partition member includes a water stop part in each of right and left end parts of the partition member, and the water stop part is covered with the crown member in a state where the partition member is disposed above the electric equipment.

2. The electric storage apparatus according to claim 1, wherein
the partition member supports a temperature control apparatus configured to cool a refrigerant for cooling the electric equipment, and forms a temperature control space inside the housing,
the housing includes a first communication port and a second communication port each configured to communicate with the temperature control space, and
the temperature control apparatus is disposed in an air flow path between the first communication port and the second communication port.

3. The electric storage apparatus according to claim 2, wherein
the first communication port is disposed in a rear part of the housing,
the second communication port is disposed in at least one of a left part of the housing and a right part of the housing,
the partition member includes a support part that supports the temperature control apparatus, and a wall part that rises upward from a front end part of the support part, the wall part being configured to guide air that has flown into the temperature control space through the first communication port and then passed through the temperature control apparatus to the second communication port, and
the water stop part is formed in each of the support part and the wall part.

4. The electric storage apparatus according to claim 1, wherein the water stop part has a labyrinth structure.
